(19) United States
(12) Patent Application Publication
(10) Pub. No.: US 2010/0132606 A1
(43) Pub. Date: Jun. 3, 2010

(54) Safety label

(76) Inventor: Werner Hagmaier, Muensingen (DE)

Correspondence Address: KRIEGSMAN & KRIEGSMAN, 30 TURNPIKE ROAD, SUITE 9, SOUTHBOROUGH, MA, 01772, US

(21) Appl. No.: 12/452,598

(22) PCT Filed: Jul. 8, 2008
(86) PCT No.: PCT/EP2008/005533

§ 371 Date: Jan. 11, 2010

(30) Foreign Application Priority Data
Jul. 11, 2007 (DE) 10 2007 032 620.5

(51) Int. Cl. G01D 5/12

(52) U.S. Cl. 116/204

(57) ABSTRACT

The invention relates to a safety label (11) which allows an external force acting on the safety label (11) to be visualised and which has at least one support layer (14), wherein the support layer (14) receives a function layer (18), an indicator medium (32) is provided between the function layer (18) and the support layer (14), the function layer (18) is covered by a protective layer (22) which is transparent at least in specific zones, and the function layer (18) has at least one indicator zone (24) which comprises at least one predetermined breaking point (29) that opens when said external force is exerted, such that the indicator medium (32) may pass over to an opposite side of the function layer (18) and be visible through the protective layer (22) which is transparent at least in specific zones.

The invention relates to a safety label allowing forces to be visualised.

WO 03/061960 A1 discloses a label allowing magnetic influences or magnetic forces to be visualised. This label comprises a multi-layer construction having a first substrate layer which is applied to a layer of magnetically sensitive microcapsules. The last-mentioned layer is provided with an opaque background layer which may be fixed to an object by means of an adhesive layer. The magnetically sensitive microcapsules comprise a mixture of magnetic particles in a suspending vehicle. Such magnetic particles are made of metal and are provided with first and second surfaces having different optical surfaces. When a magnetic field acts on this layer, the magnetic particles are oriented by rotation.

U.S. Pat. No. 5,079,058 discloses a laminated multi-layer construction in which a fluid layer which has on one side of the layer a powdery, magnetic material for forming a fluid film is prepared by a process that is enabled in response to the magnetic force. When the magnetic force exerts its influence, a pattern is to be produced by the magnetic elements in the fluid film which may consist, for example, of plastic and a solvent.

Such devices have the disadvantage of being costly in their fabrication. In addition, it is not possible to gather any information about a minimum magnetic force acting thereon. However, this is increasingly required, as the action of magnetic forces exceeding a certain force, albeit low, comprise negative effects such as damages or tamperings.

The invention is therefore based on the object of creating a safety label which has a simple structure and which allows the action of a force exerted on the safety label to be visualised only if a predetermined minimum force is exceeded.

This object is achieved according to the invention by the characteristics of claim 1. Other advantageous configurations and developments of the invention are mentioned in the further claims.

By the configuration according to the invention of a safety label having a function layer provided with at least one indicator zone comprising at least one predetermined breaking point, it is enabled that the indicator medium applied between a support layer and the function layer will only pass over to an opposite side of the function layer, visualising the action of a force, if a predetermined minimum force is exerted which ruptures the breaking point, thus permitting the indicator medium to pass through the breaking point and to visualise the action of force on the opposite side of the function layer. Thus it is possible to avoid an indication of smaller actions of forces which do not lead to a damaging of the object to which the safety label is applied or which do not yet lead to a tampering of the device on which the safety label is attached. This makes it possible to give precise information on the forces that have been exerted, in particular by indicating whether these have exceeded a predetermined minimum value. An information of this type may be relevant, for example, in judging damages of a device or apparatus due to acceleration forces or shocks. Additionally, it is also possible to give evidence of an instance of tampering caused by the action of magnetic forces, which is relevant, for example, in connection with the tampering of electricity supply meters where a standstill of the electricity supply meter is caused to be detected, while in actual fact electricity is being consumed.

According to an advantageous configuration of the invention, provision is made for the at least one breaking point in the indicator zone to be realised by a reduced wall thickness as compared to the layer thickness of the function layer. By the creation of a depression for forming said breaking point, the breaking point is allowed to be ruptured once the force exerted on the safety label has reached a predetermined amount. By adjusting the wall thickness remaining in the breaking point, it is possible to preset the break-open force required for opening the breaking point. This adjustment also allows to determine the minimum force that is to be visualised by the safety label in the individual applications. In the case of inferior forces, the breaking point continues to seal the indicator zone, such that the indicator medium present between the support layer and the function layer is prevented from passing through the function layer.

According to a preferred development of the invention, the breaking point is realised in such a manner as not to be ruptured. Thus, the function layer, in its non-activated condition, completely seals the indicator medium, such that the indicator medium is unable to pass over to the opposite side of the function layer, which is the case, for example, for shocks occurring during the transportation of a safety label and which do not correspond to a result that is intended to be visualised.

Furthermore, provision is preferably made for the function layer to include several indicator zones which are formed by a number of depressions in the breaking points varying between one another with respect to the remaining wall thickness of the function layer in a region apart from the indicator zones. In this manner, different intensity degrees of the action of force exerted on the safety label are visualised. It thus becomes possible to give specific information which is helpful in assessing the degree of damagings or tamperings.

The breaking point of the function layer is preferably created by embossing, stamping, or laser processing. By way of example, films having a layer thickness of less than 100 μm, in particular less than 50 μm, may be provided, with the embossing, stamping or laser processing enabling a reduction of the wall thickness, leaving a wall thickness of, for example, less than 10 μm in the breaking point.

According to a further advantageous configuration of the invention, provision is made for the function layer to be processed on one side only and to be applied to the support layer with a given tension. In particular when the breaking point is created by means of laser processing, preferably by means of an interactive laser, a bias is established in the indicator zone, more particularly in the region of the breaking point. The result of this is that for example in the occurrence of intense accelerations, an abrupt opening or bursting open of the breaking point is enabled. By means of such processing it is possible to predefine the force needed for forcing open the breaking point

The at least one indicator zone in the function layer preferably has an embossed pattern displaying an elevated region as compared with the edge region of the indicator zone, with the breaking points facing preferably towards said elevated region. By this elevated region it is achieved that forces acting both vertically and horizontally with respect to the function layer may be assessed and may cause a rupture of the breaking point in order to visualise the exerted force. Aligning the breaking points in a manner so as to correspond to the elevated region makes it possible to simplify the fabrication process.

According to a further advantageous configuration of the invention, the elevated region of the indicator zone is shaped in a pyramidal, frusto-pyramidal, conical, or frusto-conical form. This makes it possible to use simple geometries for forming the indicator zones and for visualising both horizontal and vertical forces exerted on the function layer.

Between the support layer and the function layer, an indicator medium is introduced, preferably at least in the region of the indicator zone. In the remaining region, an adhesive layer may be provided in order to enable a reliable interconnection between the support layer and the function layer.

According to a first alternative embodiment, the indicator medium consists of magnetically responsive metal particles. This makes it possible to assess the exertion of both magnetic forces and acceleration forces.

According to a further alternative configuration of the invention, provision is made for the indicator medium to be realised as a coloured powder, in particular as a dry colour former. This permits to visualise acceleration forces acting on the safety label. Such colour formers may be applied point to point, with a high degree of accuracy, to the support layer, in particular by lamination.

According to a further preferred configuration of the invention, provision is made for an adhesive located between the protective layer and the function layer to be provided in a region outside the indicator zone. This ensures that the deflectable regions adjoining the breaking point will remain freely movable, allowing an easy passage of the indicator medium.

According to a further configuration of the invention, provision is made for an adhesive provided between the protective layer and the function layer to be transparent and to be made of a non-hardening adhesive. Thus, the particles of the indicator medium, once they have passed through the breaking point, may be received in the not yet hardening adhesive and fixed therein, permitting to obtain an irreversible visualisation.

According to a further advantageous configuration of the invention, provision is made for an elevated region of the indicator zone to be provided with an activator for facilitating the opening of the at least one breaking point. At the same time, an activator of this type enables a defined opening of the at least one breaking point to be operated both by the mass of the activator as well as by the size and the material properties thereof.

Preferably, the activator is shaped in the form of a ball. When used as an acceleration force indicator, an activator of this type may thus be adapted in such a manner that the remaining wall thickness of the breaking point is a function of the mass of the activator. When used in a safety label allowing magnetic influences to be visualised, the activator may be formed of a ferritic material, with the acceleration force of an exerted magnetic field being taken into consideration for determining the mass of the activator. Preferably, the activator is introduced in the course of a lamination process. This allows a defined arrangement and positioning within the indicator zone relative to respective breaking point.

The invention, as well as other advantageous embodiments and developments thereof, will be described and explained in the following with reference being made to the examples shown in the drawings. The characteristics issuing from the description and the drawings may be applied according to the present invention either individually or as a plurality of features taken in any combination. In the drawings:

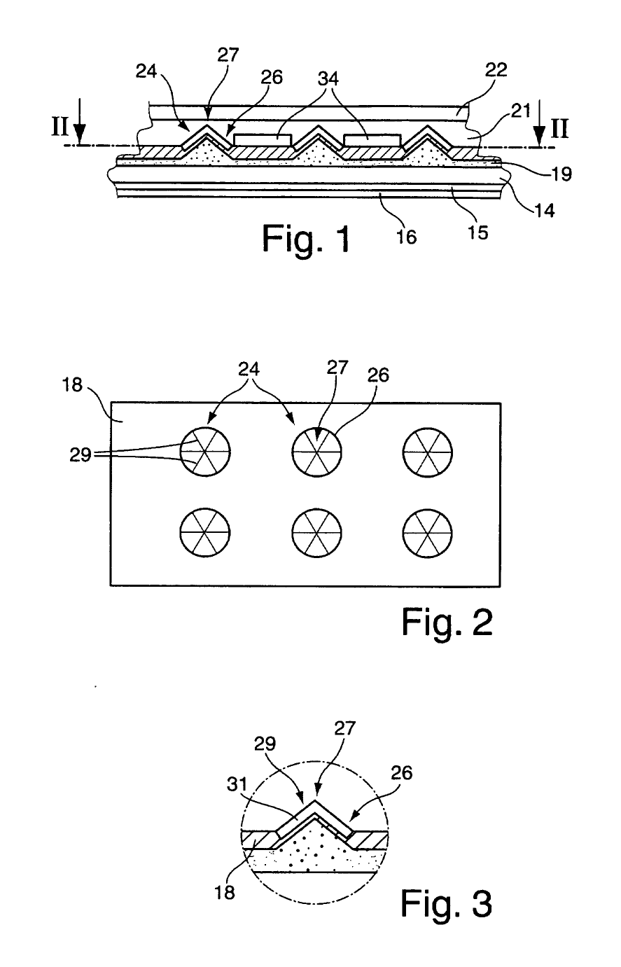

FIG. 1 is a schematic side view of a multi-layer construction of a safety label according to the present invention;

FIG. 2 is a schematic sectional view taken along the line II-II in FIG. 1;

FIG. 3 is a schematically enlarged sectional view of the indicator zone in FIG. 1;

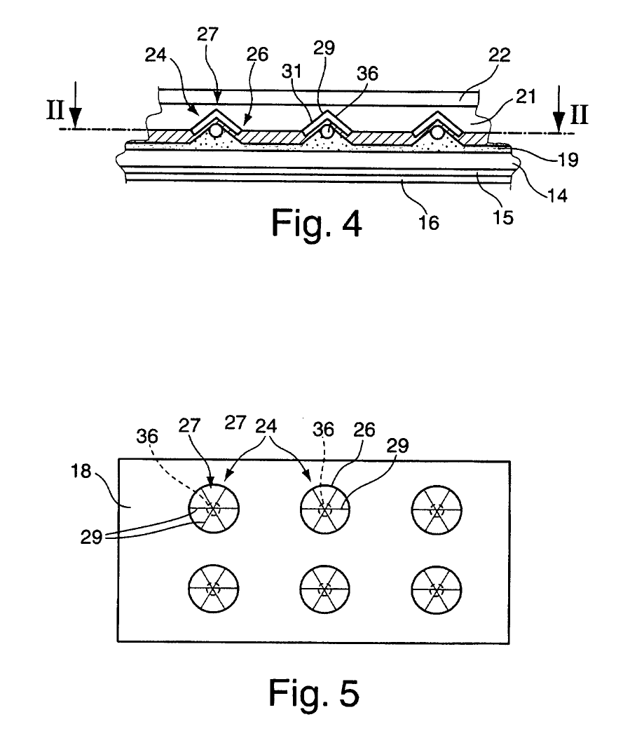

FIG. 4 is a schematic sectional view of an alternative embodiment of a safety label according to the present invention; and

FIG. 5 is a schematic sectional view taken along the line V-V in FIG. 4.

FIG. 1 is a schematically enlarged sectional view of a safety label 11 according to the present invention. Safety labels 11 of this type allow forces acting thereon to be visualised and preferably have a planiform extension ranging from some few square millimetres to several square centimetres. The safety label 11 comprises a support layer 14 which, according to the exemplary embodiment, is provided with a strongly adherent adhesive layer 15 and with a protective film 16 disposed thereon. A protective film 16 of this type is removed just before attaching the safety label 11 to its destination location, such that a self-adhesive safety label 11 is formed which may be affixed to the destination location.

On a surface opposite the adhesive layer 15, the support layer 14 receives a function layer 18 with the aid of an adhesive layer 19 which is provided, at least in specific zones, between the function layer 18 and the support layer 14. An adhesive layer 21 is in turn applied at least to specific zones of the function layer 18, in order to cover the function layer 18 with a protective layer 22. This protective layer 22 is transparent, at least in specific zones.

The function layer 18 represented in FIG. 1 has indicator zones 24 which are represented in a top view in FIG. 2 and in an enlarged sectional view in FIG. 3. These indicator zones 24 comprise an elevated region 27 as compared with an edge region 26. In the exemplary embodiment, this indicator zone 24 is shaped in a pyramidal or conical form, when considered in its cross-section. Alternatively, provision may be made for the geometry of the cross-section to have a frusto-conical or a frusto-pyramidal or similar form. The indicator zone 24 comprises at least one breaking point 29 which is represented in an enlarged view in FIG. 3. A breaking point 29 of this type is formed by a reduced wall thickness of the function layer 18. This reduced wall thickness is formed by a depression 31 which is created, for example, by embossing, stamping, or laser processing. Provision is made, however, for the depression 31 not to rupture the wall thickness of the function layer 18, such that in its initial condition, the function layer 18 forms a hermetically sealed plane with respect to the protective layer 22.

An indicator medium 32 is provided between the function layer 18 and the support layer 14, in particular in the region of the indicator zone 24. This indicator medium 32 may be introduced into the adhesive layer in the region of the indicator zone 24. Alternatively, provision may be made for the adhesive layer 19 not to extend to the region situated beneath the indicator zone 24 and for the indicator medium 32 to be provided exclusively in said region beneath the indicator zone 24 and to be laterally surrounded by the adhesive layer 19.

The indicator medium 32 may be provided in the form of magnetically responsive metal particles situated in a region beneath the indicator zone 24. The utilisation of magnetically responsive metal particles allows the exertion of magnetic forces to be visualised. The action of magnetic forces may be used, for example, to tamper electricity supply meters in order to bring them to a standstill, such that the electricity supply meter is halted despite the fact that electricity is being consumed.

Furthermore, the indicator medium 32 may be realised in the form of a dry colour former. An indicator medium of this type is used, for example, for allowing acceleration forces to be visualised. This makes it possible to visualise occurring acceleration forces, in particular strokes, shocks, or an impact, in order to be able to reconstruct which forces have been exerted on an object or an apparatus. By way of example, the impact of a housing on the floor, caused by inadvertent handling of the apparatus, such as a camera or a delicate measuring instrument, may be established and evidence thereof may be provided. Thus, a safety label of this type is a valuable means of assessing the legitimacy of potential warranty claims.

The indicator zone 24, which is represented in an enlarged view in FIG. 3, has the depression 31 on the side of the surface of the function layer 18 which forms the elevated region 27. Therefore, the continuous surface faces towards the indicator medium 32, thus precluding a potential, partial introduction of the indicator medium 32 into the depression 31, which would have a negative effect on the defined opening force of the breaking point 29. With a function layer 18 having a layer thickness of 10 μm to 100 μm, the depression 31 may be, for example, 1 μm to 2 μm. By introducing a temperature into the depression 31 during treatment with an interactive laser, a defined bias is achieved in the indicator zone 24, such that upon the action of an acceleration force, for example by a shock, an impact, or a stroke, an abrupt bursting open of the breaking point 29 is enabled. This permits the indicator medium 32 to pass through to the opposite side of the function layer 18, giving evidence of the exerted force by the particles of the indicator medium 32 having migrated into the space between the protective layer 22 and the function layer 18, the protective layer 22 being transparent, at least in the region of the indicator zone.

The safety label 11 may, for example, have a plurality of indicator zones 24 situated side by side, the breaking points 29 of which being each provided with a differently shaped depression 31. For example, the first breaking point may have a remaining wall portion of 1 μm and the second breaking point a remaining wall portion of 2 μm. This allows acceleration forces acting with different intensities to be visualised. Furthermore, provision may be made for the safety label 11 to have at least two indicator zones 24 with an identical depression 31 for forming the breaking point 29, which enables a redundant visualisation and thus a means of self-testing of the indication of exerted force.

The number and disposition of the breaking points 29 according to FIG. 2 is merely exemplary. It is also envisageable to provide only one or two breaking points 29 in the indicator zone 24 for allowing the indicator medium 32 to pass through the function layer 18 into the region of the indicator zone 24.

In order to ensure a uniform structure of the individual layers, a coating 34 may further be provided between the function layer 18 and the adhesive layer 21, said coating being applied on the function layer 18 in a region outside the indicator zones 24. This coating 34 may thus provide a lining permitting to overcome the level difference between the elevated region 27 of the indicator zone 24 and the edge region 26 passing into the level of the function layer 18 or lying therein. A lining of this type may be enabled by colour printing, in particular by a screen printing technique.

As far as the fabrication of a multi-layer construction 12 of this type for a safety label 11 is concerned, provision is made for the indicator zones 24 to be first introduced into the function layer 18. The depression 31 for forming the at least one breaking point 29 may be created by means of stamping, embossing or laser processing, whereupon the configuration of the elevated region 27 is realised by means of an embossed pattern. Provision may also be made for these steps to be carried out simultaneously or in reverse order. Subsequently, the indicator medium 32 and an adhesive layer 19 are applied to a bottom surface of the function layer 18. Once the application of adhesive, for example a hot-melt adhesive, has been accomplished, the support layer 14 may be applied. This support layer 14 may already comprise the protective film 16. On the opposite side of the function layer 18, the coating 34 is applied, for example by means of a screen printing technique, until the level difference between the edge region 26 and the elevated region 27 has been overcome. Subsequently, the adhesive layer 21 is laminated onto the structure, with the laminating of the protective layer 22, which is at least partly transparent, preferably in the region of the indicator zone 24, taking place either simultaneously or at a later stage.

FIG. 4 represents a schematic sectional view of a safety label 11 according to an alternative embodiment, differing from FIG. 1. FIG. 5 represents a top view of the function layer 18 and its indicator zone 24 according to an alternative embodiment, differing from FIG. 4. In the following, only the differences will be described. As far as the coinciding features are concerned, reference is made to the above description relating to FIGS. 1 to 3.

In the elevated region 27 of the indicator zone 24, an activator 36 is provided which is shaped, for example, in the form of a ball. This activator 36 is introduced from a bottom surface of the function layer 18 or, in other words, is provided on the side of the function layer 18 which is situated opposite the depression 31. Upon the exertion of forces, this activator 36 is designed to provide a defined, abrupt bursting-open of the breaking point 29 within the indicator zone 24. In particular upon the occurrence of acceleration forces, the bursting-open of the breaking point 29 caused by the stroke, shock, or impact, may be supported by the activator 36. The activator 36 is introduced, for example, by lamination and is positioned in the elevated region 27. If necessary, the activator 36 may be slightly pressed into the elevated region 27 during the lamination process, so as to achieve both a further reduction of the wall thickness and an increased bias. The size of the actuator 36 as well as the material properties thereof may again determine the opening force.

Any one of the characteristics described above is in itself relevant with regard to the invention and they may be combined with one another without restriction.

1. A safety label which allows an external force acting on the safety label to be visualised and which has at least one support layer, which receives a function layer and is covered by a protective layer which is transparent at least in specific zones, an indicator medium is being provided between the function layer and the support layer, wherein the function layer has at least one indicator zone which comprises at least one predetermined breaking point configured in such a manner that the function layer is not ruptured in the region of the breaking point and that the breaking point is only ruptured that opens when a predetermined external force is exerted, so that the indicator medium may pass over to an opposite side of the function layer and be visible through the protective layer which is transparent at least in specific zones.

2. The safety label as claimed in claim 1, wherein the at least one breaking point in the indicator zone is formed by a depression by which the layer thickness of the function layer is reduced.

3. (canceled)

4. The safety label as claimed in claim 1, wherein several indicator zones are provided which are formed by depressions differing from one another and realised in the respective breaking points.

5. The safety label as claimed in claim 1, wherein the at least one breaking point of the function layer is created by embossing, stamping, or laser processing.

6. The safety label as claimed in claim 1, wherein the function layer is processed on one side only and is applied to the support layer with a given tension.

7. The safety label as claimed in claim 1, wherein the indicator zone has an embossed pattern displaying an elevated region as compared with the edge region and that the at least one breaking point is preferably provided in said elevated region.

8. The safety label as claimed in claim 7, wherein the elevated region of the indicator zone is shaped in a pyramidal, frusto-pyramidal, conical, or frusto-conical form.

9. The safety label as claimed in claim 1, wherein an indicator medium is introduced at least in the indicator zone and that an adhesive is provided in specific sections at least between the support layer and the function layer.

10. The safety label as claimed in claim 1, wherein the indicator medium comprises magnetically responsive metal particles.

11. The safety label as claimed in any of the claims 1 to 2 or 4 to 9, wherein the indicator medium is realised as a coloured powder or as a dry colour former.

12. The safety label as claimed in claim 1, wherein an adhesive layer provided between the protective layer and the function layer is provided in a region outside the indicator zone.

13. The safety label as claimed in claim 1, wherein an adhesive layer provided between the protective layer and the function layer is transparent and consists of a non-hardening adhesive.

14. The safety label as claimed in claim 1, wherein an activator for facilitating the opening of the at least one breaking point is provided in the indicator zone.

15. The safety label as claimed in claim 14, wherein the activator is provided in the elevated region of the indicator zone.

16. The safety label as claimed in claim 13 or 14, wherein the activator is shaped in the form of a ball that is introduced into the indicator zone in the course of a lamination process.

17. The safety label as claimed in claim 15 wherein the activator is introduced on the side of the function layer situated opposite the depression.
